(19) United States
(12) Patent Application Publication
(10) Pub. No.: US 2005/0283641 A1
(43) Pub. Date: Dec. 22, 2005

(54) Apparatus, system, and method for verified fencing of a rogue node within a cluster

(75) Inventors: Thomas Keith Clark, Gresham, OR (US); Sudhir Gurunandan Rao, Portland, OR (US)

Correspondence Address: KUNZLER & ASSOCIATES, 8 EAST BROADWAY, SUITE 600, SALT LAKE CITY, UT, 84111, US

(73) Assignee: INTERNATIONAL BUSINESS MACHINES CORPORATION, Armonk, NY (US)

(21) Appl. No.: 10/850,678

(22) Filed: May 21, 2004

(51) Int. Cl. G06F 11/00

(52) U.S. Cl. 714/4

(57) ABSTRACT

An apparatus, system, and method are provided for verified fencing of a rogue node within a cluster. The apparatus may include an identification module, a shutdown module, and a confirmation module. The identification module detects a cluster partition and identifies a rogue node with a cluster. The shutdown module sends a shutdown message to the rogue node using a message repository shared by the rogue node and the cluster. The shutdown message may optionally permit the rogue node to preserve latent I/O data prior to shutting down. The confirmation module receives a shutdown ACK from the rogue node 206. Preferably, the shutdown ACK is sent just prior to the rogue node actually shutting down.

### BACKGROUND OF THE INVENTION

1. Field of the Invention

The invention relates to cluster computing. Specifically, the invention relates to apparatus, systems, and methods for verified fencing of a rogue node within a cluster.

2. Description of the Related Art

Cluster computing architectures have recently advanced such that clusters of computers are now being used in the academic and commercial community to compute solutions to complex problems. Cluster computing offers three distinct features for scientific research and corporate computing: high performance, high availability, and less cost than dedicated super computers.

Cluster computing comprises a plurality of conventional workstations, servers, PCs, and other computer systems interconnected by a high speed network to provide computing services to a plurality of clients. Each computer system (PC, workstation, server, mainframe, etc.) is a node of the cluster. The cluster integrates the resources of all of these nodes and presents to a user, and to user applications, a Single System Image (SSI). The resources, memory, storage, processors, etc. of each node are combined into one large set of resources. To a user or user application, access to the resources is transparent and the resources are used as though present in a single computer system.

FIG. 1 illustrates a conventional cluster system 100 including a cluster 102 and clients 104. The cluster 102 comprises a plurality of computers, referred to as nodes 106, typically located relatively close to each other geographically. Clusters 102 can, however, include nodes 106 separated by large distances and interconnected using a Local Area Network (LAN), such as an intranet, or Wide Area Network (WAN), such as the Internet. The cluster 102 can service applications as a parallel or distributed processing system. The nodes 106 can each execute the same or different operating systems. The management, coordination, and messaging between the nodes 106 is conducted by the SSI and System Availability (SA) infrastructure, i.e. cluster middleware.

Each node 106 communicates with the other nodes 106 using high speed, high performance network communications 108 such as Ethernet, Fast Ethernet, Gigabit Ethernet, Myrinet, Digital Memory Channel, and the like. The network communications 108 implement fast communication protocols such as Active Messages, Fast Messages, U-net, XTP, and the like.

Various user applications use the services made available from the cluster 102. These applications are referred to herein as clients 104. Examples of client applications 104 include web servers, data mining clients, parallel databases, molecular biology modeling, weather forecasting, and the like.

Generally, the nodes 106 are connected to one or more persistent storage devices 110 such as a Direct Access Storage Device (DASD). Generally, one or more of the persistent storage devices 110 are shared between the nodes 106 of the cluster 102. The type and architecture of the persistent storage devices may vary. For example, each node 106 can connect to a plurality of disk drives, a Redundant Array of Independent Disk (RAID) systems, Virtual Tape Servers (VTS), and the like.

Typically, these persistent storage devices 110 are connected to the nodes 106 via a Storage Area Network (SAN) 112. The nodes communicate with the storage devices or storage subsystems using high speed data transfer protocols such as Fibre Channel, Enterprise System Connection® (ESCON), Fiber Connection (FICON) channel, Small Computer System Interface (SCSI), SCSI over Fibre Channel, and the like. Of course the SAN 112 generally includes other controllers, switches, and the like for supporting the data transfer protocol which have been omitted for clarity.

As mentioned above, one benefit of a cluster 102 is high availability. A cluster 102 is generally designed to minimize single points of failure. Even shared storage devices 110 may be mirrored. If one part of the cluster 102 fails, the cluster 102 is designed to transparently adapt to the failure and continue to provide services to the clients 104.

To provide high availability, the cluster 102 includes management software referred to as a System Availability (SA) infrastructure. The SA automatically provides services to ensure high availability. One of these services is failover. Failover refers to the identification of a failed node 106 and movement of shared resources from the failed node over to another operating node 106. By performing failover, services previously provided by the cluster 102 continue to be provided within a minimal delay or impact on performance. Failure of the one node 106 does not result in permanent loss of cluster services. Generally, failover is managed and implemented by a leader node 106 designated in FIG. 1 by the letter “L.”

The shared resources can include applications, process threads, memory data structures, I/O devices, storage devices and associated file systems, and the like. Although each node 106 can access each shared resource of the cluster 102, a control protocol requires that access be regulated by an owner of the shared resource. Typically, each shared resource has an associated owner node 106. Although ownership may change dynamically, generally each shared resource has only one owner at any given time. This helps ensure data integrity for each resource, in particular within shared storage devices 110. The owner node 106 ensures that Input/Output (I/O) operations are performed on the shared resource atomically to preserve data integrity.

Various faults can occur in a cluster 102 that will trigger failover. Application faults, Operating System (OS) faults, and node hardware faults are specific to a node 106 and generally handled by each node 106 individually. The most common faults triggering failover are network faults.

Network faults are the loss of regular network communications between one or more nodes 106 and the other nodes 106 in the cluster 102. Network faults may be caused by a failed Host Bus Adapter (HBA), network adapter, switch, HUB, or by software defects. Clusters 102 are designed to be fault tolerant and adapt to such network faults without compromising the integrity of any of the data of the cluster 102.

Failover, together with certain pre-failover protocols provide the desired fault tolerance. It is desirable that failover guarantee that no data is corrupted either due to the fault or operation of the failover process. Consequently, ownership of shared resources should remain clear for all nodes 106 of the cluster 102. In addition, it is desirable that no data be lost due to operation of the failover process. Furthermore, it is desirable that failover be completed as quickly as possible such that the cluster 102 can continue to provide computing services on a 24×7 schedule.

Generally, a network fault causes one or more nodes 106 to lose communication with the other nodes 106 of the cluster 102. Nodes 106 that have lost communication with the cluster 102 are referred to as rogue nodes 106 and designated in FIG. 1 by the letter “R.” This break in network communications breaks or partitions the cluster 102 into at least two cluster sections. Such a division of the cluster 102 is referred to as a network cluster partition 114.

A quorum protocol addresses the network cluster partition 114 condition at a software application level. The quorum protocol controls whether a node 106 is permitted to read and write to shared resources such as a shared storage device 110. Various implementations of a quorum protocol, well known to those of skill in the art, indicate to a node 106 whether it or its sibling nodes has quorum. Having quorum means that the node 106 has control over the cluster 102 and the cluster resources. Quorum may be held by a single node 106 or a section of nodes 106. If the node 106 or a cluster section containing that node 106 has quorum, the node 106 can write to a shared resource. If the node 106 or a cluster section containing that node 106 does not have quorum, the node 106 agrees to not attempt to write to a shared resource and voluntarily withdraws from the cluster 102.

Often, the quorum protocol satisfactorily preserves data integrity. Unfortunately, the quorum protocol does not provide absolute assurance that a rogue node 106 will not make I/O writes that can corrupt data in the shared resources 110. In particular, the rogue node 106 could lose communication with the cluster 102, but still presume to have quorum for a brief period for writing data to shared resources assigned to that node 106 and corrupting data.

User actions can cause a node 106 to lose network communication and be branded as rogue by the cluster 102 even though the node 106 is operating normally but temporarily unresponsive. For example, a user may pause the execution of the OS, such as for debugging purposes, which causes the node to fail to provide the typical heartbeat message used to monitor nodes 106 in the cluster 102. Alternatively, a network cable may be unplugged.

Consequently, the node 106 is branded a rogue node 106 by the cluster and quorum is removed from the node 106. If execution of the OS is resumed, I/O operations of the node 106 queued for a resource (shared or independently owned) can be written out before the node 106 detects that it has lost quorum. These I/O writes could be conducted over a SAN connection 112 or a direct I/O connection. Consequently, the rogue node 106 has written data to a cluster resource without proper authority and potentially corrupted shared data.

Accordingly, various fencing protocols have been implemented to assure that a rogue node 106 does not corrupt cluster data, data integrity is preserved. As used herein, fencing refers to a process that, without the cooperation of a node 106, isolates the node 106 from writing to any cluster data resources. Referring still to FIG. 1, fencing logically comprises placing an I/O fence 116 between the rogue node 106 and the cluster data such as a storage device 110. Typically, fencing is completed prior to initiating a failover process.

Various types of proposed fencing solutions have been implemented with limited success. Fencing solutions can be hardware based, software based, or a combination of hardware and software. For example, if the cluster data resource is accessed using the SCSI communications protocol, the cluster 102 can reserve access to the data resources currently owned by the rogue node 106 using a SCSI reserve/release command or a persistent SCSI reserve/release command. The reserved access then prevents the rogue node 106 from accessing the resource.

Alternatively, a fiber channel switch can be commanded to deny the rogue node 106 access to fiber channel storage devices. Unfortunately, these proposed solutions rely on proprietary hardware specific solutions that have not yet become standards. Furthermore, these technologies are not yet mature enough to support interoperability. Consequently, hardware and software dependencies exist between the fencing solution and the nodes 106, network connections, and data connections. These dependencies lock a cluster design into using a select few different technologies. Furthermore, because these proposed solutions have not yet been fully accepted, use of one solution could hinder interoperability in certain cluster environments. In addition, this proposed solution fails to preserve latent data in the rogue node's cache and subsystems, as explained below.

Another conventional fencing solution is remote power control over the rogue node 106, also referred to as Shoot The Other Node In The Head. (STONITH). In this solution, special hardware is used to reboot a rogue node 106 without the rogue node's 106 cooperation. The cluster 102 sends a power reset command to the special hardware which cuts off power to the rogue node 106 and then restores power after a certain period. This proposed solution also fails to preserve latent data in the rogue node's cache and subsystems, as explained below.

Still another proposed fencing solution involves leasing of resources. The rogue node 106 holds ownership of a resource for a predetermined time period. Once the time period expires, the rogue node 106 voluntarily releases ownership of the resource. The leader of the cluster or a lease manager can then refuse to renew a lease for a rogue node 106 in order to protect data integrity.

Unfortunately, under this fencing technique, the fencing protocol could take at least as long as the predetermined time period for the leases. This time period is often longer than the acceptable delay permissible before initiating failover. In addition, the nodes 106 typically do not have synchronized clocks. Consequently, there can be an overlap between when the cluster leader believes the lease to be expired and when the rogue node 106 considers the lease expired. This time overlap can also lead to data corruption. To overcome such a potential time overlap, leasing protocols include additional delays to be certain the lease has expired.

So, conventional fencing solutions are dependent on special hardware or storage technology that is either unreliable or not universally implemented. In addition, conventional fencing solutions fail to prevent data loss. For optimization, cluster nodes 106 often cache I/Os queued for writing to a storage device 110. These queued I/Os could be written to the storage device 110 in batches or according to various storage network optimization protocols. With inexpensive memory devices available, significant quantities of data can reside in these queues. The queues can reside on various devices including storage subsystems, I/O cards, and other I/O devices operating below the OS level of the node 106.

Certain conventional fencing solutions such as the SCSI reservation and resource leasing prevent these queued I/Os from reaching the storage device 110. Resetting the power to the node 106 causes the queued I/Os to disappear. Consequently, the data represented by the queued I/Os is lost.

One challenge in fencing a rogue node 106 is that the rogue node 106 is uncooperative or even unaware that it is considered a rogue node 102 by the cluster 102. Furthermore, it is known that the network communications are experiencing faults. Consequently, a leader 106 can not be assured that fencing techniques initiated by a remote node 106 are effective. Conventional fencing solutions do not include a confirmation that the fencing technique was successful and did not experience an additional fault.

From the foregoing discussion, it should be apparent that a need exists for an apparatus, system, and method for verified fencing of a rogue node within a cluster. Beneficially, such an apparatus, system, and method would preserve I/O data queued within a rogue node 106 for a cluster resource. In addition, the apparatus, system, and method would not rely on sparsely implemented technologies or specialized hardware, would allow for fast verified fencing to reduce the delay before initiating failover, and would prevent data corruption. In addition, such an apparatus, system, and method would provide confirmation that the fencing operation was successful.

### SUMMARY OF THE INVENTION

The present invention has been developed in response to the present state of the art, and in particular, in response to the problems and needs in the art that have not yet been met for verifying fencing of a rogue node in a cluster. Accordingly, the present invention has been developed to provide an apparatus, system, and method for verified fencing of a rogue node in a cluster that overcomes many or all of the above-discussed shortcomings in the art.

An apparatus according to the present invention includes an identification module, a shutdown module, and a confirmation module. The identification module detects a network cluster partition and identifies a rogue node within a cluster. The shutdown module sends a shutdown message to the rogue node using a message repository shared between the rogue node and the cluster. Preferably, the message repository is on a storage device such as a disk or a non-network based resource. The shutdown message may be sent exclusively by a leader node.

Preferably, the apparatus is configurable using an interface such that the shutdown message may comprise a hard shutdown message or a soft shutdown message. Hard shutdown messages may reduce failover delay but lose latent data of the rogue node. A soft shutdown message may permit the rogue node to move latent data to persistent storage prior to shutting down but increase the failover delay. The shutdown message may optionally reboot a node or an I/O subsystem of the node.

Preferably, the shared message repository comprises a persistent storage device such as a disk storage device. In addition, the data communication channels between the shared message repository and cluster nodes are preferably highly reliable and minimally affected by network communication faults. The shared message repository is accessible to each node on the cluster and may include a unique receive message box and a separate response message box for each node.

In certain embodiments, the apparatus includes a parallel operation module that conducts a cluster reformation process concurrent with verified fencing of the rogue node. By concurrent operation, certain embodiments are capable of completing fencing and cluster reformation more quickly such that failover delays are minimized.

In another embodiment, the shared message repository may be used to issue a warning message to a second cluster section that a first cluster section is attempting to define a leader node and reform the cluster. The warning message may be sent by a leader candidate node presuming to be the leader of the cluster. Consequently, if the first cluster section fails to take control of the cluster, the second cluster section may then attempt to define a leader and reform the cluster. In this manner, a second cluster section can reform the cluster if a second fault prevents the first cluster section from taking over.

A method of the present invention is also presented for verifying fencing of a rogue node in a cluster. In one embodiment, the method includes detecting a network cluster partition and identifying a rogue node within a cluster. The method sends a shutdown message to the rogue node using a message repository shared by the rogue node and the cluster. Lastly, the method receives a shutdown acknowledgement (ACK) from the rogue node, the shutdown ACK sent just prior to the rogue node shutting down.

The present invention also includes embodiments arranged as a system, alternative apparatus, additional method steps, and machine-readable instructions that comprise substantially the same functionality as the components and steps described above in relation to the apparatus and method. The present invention provides a generic verified fencing solution that preserves data integrity, optionally prevents data loss, and reduces the failover delay in handling a network cluster partition. The features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating a conventional cluster system experiencing a cluster partition and including a rogue node;

FIG. 2 is a logical block diagram illustrating one embodiment of the present invention;

FIG. 3 is a schematic block diagram illustrating one embodiment of an apparatus in accordance with the present invention;

FIG. 4 is a schematic block diagram illustrating one embodiment of a system in accordance with the present invention;

FIG. 5A is a schematic block diagram illustrating an example of messaging data structures suitable for use with one embodiment of the present invention;

FIG. 5B is a schematic block diagram illustrating an example of fields for messages used to perform verified fencing operations of a rogue node in accordance with one embodiment of the present invention;

FIG. 6 is a schematic block diagram illustrating one embodiment of the present invention that facilitates cluster reformation and takeover using a shared message repository; and

FIG. 7 is a schematic flow chart diagram illustrating one embodiment of a method for verifying fencing of a rogue node in a cluster.

### DETAILED DESCRIPTION OF THE INVENTION

It will be readily understood that the components of the present invention, as generally described and illustrated in the Figures herein, may be arranged and designed in a wide variety of different configurations. Thus, the following more detailed description of the embodiments of the apparatus, system, and method of the present invention, as presented in the Figures, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, function, or other construct. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, software modules, user selections, user interfaces, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

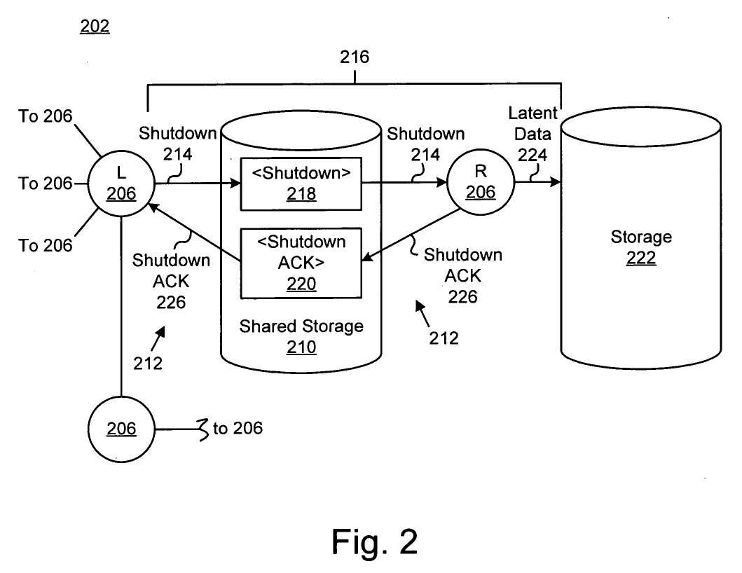

FIG. 2 illustrates a logical block diagram of a cluster 202 configured for verified fencing of a rogue node 206 in the cluster 202. The cluster 202 includes a plurality of nodes 206 each operating one or more servers that provide services of the cluster 202 to clients (not shown). Each node 206 communicates with other nodes 206 using a network interconnect such as TCP/IP, Fiber Channel, SCSI, or the like. Each node 206 also has an I/O interconnect to a persistent storage device 210 such as a disk drive, array of disk drives, or other storage system. The persistent storage device 210 is shared by each node 206 in the cluster 202.

Preferably, the I/O interconnect is a communication link such as a SAN 212 and is separate from the network interconnect. Alternatively or in addition, the network interconnect and the I/O interconnect may share the same physical connections and devices. The cluster 202 has a leader node 206 “L.” Now suppose, a network fault occurs in the cluster 202.

Typically, a cluster 202 includes logic to periodically verify that each node 206 of the cluster 202 is active, operable, and available for providing cluster services. Protocols for monitoring the health and status of cluster nodes 206 typically includes a network messaging technique that refers to periodically exchanged messages as “heartbeats.” The protocol operates on the principle that active, available members of the cluster 206 agree to exchange heartbeat messages or otherwise respond at regular intervals to confirm cluster network connections and/or that the node 206 and its servers are fault-free.

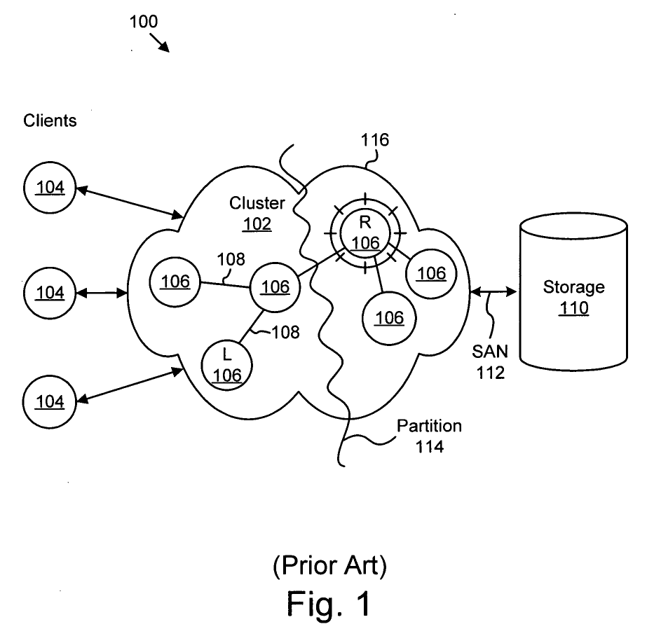

Consequently, with a heart beat or other monitoring protocol operating, a leader node 206 can quickly identify faults in the cluster 202. Once a fault is identified, steps well known to those of skill in the art are taken to determine what type of fault has occurred. If a node 206 loses network communication with a cluster 202, the fault is a network fault and the node 202 may be identified as a rogue node 206 “R” within the cluster 202. A network fault constitutes a network cluster partition 114 (See FIG. 1) that divides the cluster 202.

Of course, various protocols may be used to detect a network cluster partition 114 and identify a rogue node 206. In one embodiment, failure of a node 206 to provide a heartbeat message may be sufficient to signal a network cluster partition 114 and identify a node 206 as a rogue node 206. Such protocols are well known to those of ordinary skill in the art of cluster computing.

Furthermore, how the determination is made that a node 206 is a rogue node 206 depends largely on the cluster management protocols implemented. In certain instances, failure by a node 206 to respond to one or more messages from a leader node 206 may signal a network fault. Those of skill in the art will recognize that there may be other more complicated or simple protocols implemented for identifying a node 206 as a rogue node 206. All of these protocols are considered within the scope of the present invention.

Initially a network cluster partition 114 is detected and one or more nodes 206 are identified as rogue nodes 206. Next, a shutdown message 214 is sent to the rogue node 206. Preferably, the shutdown message 214 is sent by the leader 206 of the cluster 202.

The shutdown message 214 is preferably sent using a secondary communication channel 216. The secondary communication channel 216 is a reliable, fault-tolerant, communication channel 216 other than the primary communication channel which is often used for regular network communications. Nodes 206 may communicate using the secondary communication channel 216 when network faults prevent use of the primary communication channel. While, the secondary communication channel 216 may not perform the full features of the primary communication channel such as high speed robust cluster communications, the secondary communication channel 216 is adequate for handling network faults. The secondary communication channel 216 may comprise one or more redundant physical connections between the nodes 206 or a logical connection made possible by shared resources.

In one embodiment, the secondary communication channel 216 comprises a messaging protocol that exchanges messages over a shared repository 210 such as, for example, a shared storage device 210. Such a messaging protocol may be referred to as a disk-based protocol. Preferably, each node 206 has shared access to the shared storage device 210.

The shared storage device 210 may comprise a data center, RAID array, VTS, or the like. Preferably, the shared storage device 210 is persistent such that if the device 210 is connected directly to the node 206 rebooting the node 206 will not erase messages within the storage device 210. Furthermore, a persistent shared storage device 210 is typically more fault-tolerant than non-persistent devices.

The messaging protocol may be implemented such that each node 206 has a unique receive message box 218 and a separate response message box 220. Messages are exchanged between nodes 206 in a similar manner to a postal mailbox. Messages intended for a node 206 are written to the receive message box 218. Response messages the node 206 wants to communicate are written to the response message box 220.

Alternatively, the receive message box 218 and response message box 220 may comprise the same memory space. In such an embodiment, the leader node 206 may wait a predefined time period before checking for a response message, i.e., a shutdown acknowledgement (ACK) 226. If no response message is left after that predefined time period, the leader node 206 may resort to more drastic fencing techniques that may not preserve latent data.

In the embodiment illustrated in FIG. 2, a node 206 writes the shutdown message 214 to the appropriate receive message box 218 for the rogue node 206. Preferably, the right to send a shutdown message 214 is reserved for the leader node 206 of the cluster 202. Alternatively, another cluster managing module may issue the shutdown message 214. The rogue node 206 is configured to periodically check the receive message box 218 assigned to it. Consequently, the rogue node 206 reads the shutdown message 214 from the receive message box 218.

Furthermore, the rogue node 206 is configured to comply with requests made using the receive message box 218. The shutdown message 214 directs the rogue node 206 to shutdown. Implementations of a shutdown message may require that the rogue node 206 power off, reset an I/O subsystem, reboot, restart certain executing applications, perform a combination of these operations, or the like.

Preferably, the shutdown message 214 comprises one of two different types of shutdown commands. The shutdown message 214 may comprise a hard shutdown message or a soft shutdown message. A hard shutdown message causes the rogue node 206 to immediately either terminate power for the node 206 or abruptly interrupt all executing processes and turn the power off (also referred to as power off). Optionally, once power is off a hard shutdown command may then restart the node 206. In either case, the hard shutdown message quickly terminates power to the rogue node 206.

As mentioned above, cluster nodes 206 typically place I/O communications in queues and/or buffers that are staged to be sent to a storage device 222 at a later time for optimization. For example, batches of I/O data may be sent to optimize use of the storage interconnect and/or storage device 222. These buffers and queues are typically located in hardware devices of the rogue node 206 such as network cards, storage subsystems, and the like. This I/O data is referred to herein as latent data or latent I/O data.

The latent data is data that exists in non-persistent memory devices of the rogue node 206. The latent data resides in the queues awaiting transfer to persistent storage. If power is shutoff to the rogue node 206, latent data in the queues is lost. If the rogue node 206 reads a hard shutdown message 214, the latent data will similarly be lost. Conventional fencing techniques do not prevent the loss of such latent data.

Referring still to FIG. 2, if the shutdown message 214 comprises a soft shutdown message, the rogue node 206 performs a more graceful shutdown procedure than with a hard shutdown message. A soft shutdown message may cause the rogue node 206 to signal to all executing process that a hard shutdown command is pending and imminent. The rogue node 206 may then permit the executing processes sufficient time to perform software shutdown procedures needed to preserve non-persistent memory data and operating states.

As part of these software shutdown procedures, servers operating on the rogue node 206 are provided the opportunity to immediately transfer latent data 224 in any buffers and/or queues of the I/O hardware and subsystems to persistent storage 222. Other executables may additionally synchronize I/O and quiesce all I/O activity. In certain embodiments, the rogue node 206 may wait for confirmation from each executing process that software shutdown procedures are completed. Alternatively, each process may terminate naturally once software shutdown procedures are complete.

After sufficient time and/or checks are completed, the rogue node 206 prepares to execute a hard shutdown. As mentioned above, the hard shutdown causes power termination to the rogue node 206 which resets the node 206 and any non-persistent memory structures, including I/O buffers. Also as above, the rogue node 206 may optionally restore power after a short period of time and restart.

A hard shutdown message can cause loss of latent data, but fences a rogue node 206 very quickly. A soft shutdown message preserves latent data, but may introduce a delay as the latent data is transferred to storage 222. The delay may be minimal but may still be undesirable. Consequently, verified fencing of a rogue node 206 in accordance with the present invention presents a trade-off of two competing interests, preservation of latent data and faster fencing in preparation for failover. Preferably, the present invention allows for either of these interests to be selectively addressed because the type of shutdown message is configurable.

In certain embodiments, immediately prior to actually executing a hard shutdown, termination of power, either in response to a hard shutdown message or in response to a soft shutdown message, the rogue node 206 is configured to send a shutdown acknowledgement (ACK) 226 to the sender of the shutdown message 214. Preferably, the shutdown ACK 226 is sent by the rogue node 206 writing the shutdown ACK 226 to the response message box 220. The shutdown ACK 226 is written in response to the shutdown message 214. The sender of the shutdown message 214, typically the leader node 206, is configured to periodically check the response message box 220 for the shutdown ACK 226. Consequently, the leader node 206 receives the shutdown ACK 226.

By reading the shutdown ACK 226, the leader node 206 is assured that the rogue node 206 has received and complied with the shutdown message 214. The shutdown ACK provides verification that fencing of the rogue 206 was successful. Conventional fencing techniques may have to complete further checks and tests to determine whether the rogue node 206 is actually fenced. For example, conventional fencing techniques may rely on timers, network pings, and other heuristics to estimate when failover is safe under the assumption that the rogue node 206 has been successfully fenced. In contrast, the present invention provides an affirmative confirmation in the form of the shutdown ACK that the rogue node 206 has successfully been fenced.

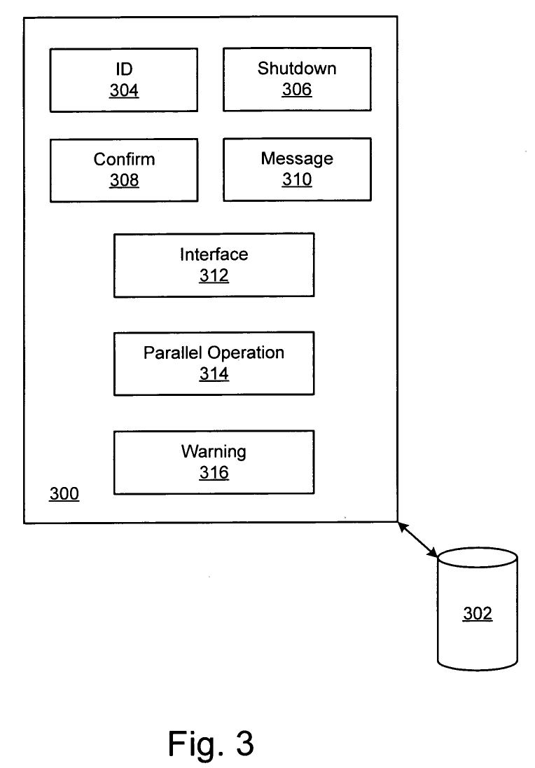

FIG. 3 illustrates an apparatus 300 according to one embodiment for verified fencing of a rogue node 206 in the cluster 202. Reference will now be made directly to FIG. 3 and indirectly to FIG. 2. Preferably, each node 206 of a cluster 202 comprises the apparatus 300. The apparatus 300 may be implemented as hardware or software.

Each apparatus 300 includes at least one I/O connection to a persistent storage device 302 that is accessible to and shared by each node 206 in a cluster 202. The I/O connection is configured to permit the apparatus 300 to read and write to the storage device 302. Specifically, the I/O connection permits the apparatus 300 to read from a receive message box 218 and write to a response message box 220.

Preferably, the I/O connection is a fault-tolerant I/O connection such that data read/write requests from the apparatus 300 may travel over a plurality of redundant paths to avoid failed or unavailable I/O connection paths. If one I/O communication channel fails, I/O communication logic and/or hardware may attempt to perform the I/O operation using a next redundant I/O communication path. This may repeat until the I/O request is successfully completed.

In this manner, the I/O connection provides a highly reliable and fault-tolerant communication path for fencing messages passed between nodes 206 sharing access to the storage device 302. In instances of a network fault and one or more I/O communication path faults, fencing messages such as a shutdown message 214 can still be exchanged using the I/O connection. Such resiliency is provided by using the storage device 302 for a disk-based communication link.

The apparatus 300 may include an identification module 304, a shutdown module 306, and a confirmation module 308. The identification module 304 detects a network cluster partition and identifies a rogue node 206 within the cluster 202. As mentioned above, detection and identification of a rogue node 206 may be performed according to well accepted clustering protocols such as a heartbeat protocol.

The shutdown module 306 sends a shutdown message 214 to a rogue node 206. As discussed above in relation to FIG. 2, the shutdown message 214 is written to the receive message box 218 for the rogue node 206 on the storage device 302. The rogue node 206 then checks the receive message box 218 and reads the shutdown message 214.

The confirmation module 308 communicates with the shutdown module 306. In response to sending of a shutdown message 214, the confirmation module 308 checks the storage device 302 for a shutdown ACK 226. Preferably, the confirmation module 308 reads the shutdown ACK 226 from a response message box 220 for the rogue node 206. Alternatively, the rogue node 206 may write the shutdown ACK 226 in the receive message box 218 of the node 206 (typically the leader node 206) that sent the shutdown message 214. Once a proper shutdown ACK 226 is received, the apparatus 300 has confirmation that the rogue node 206 has ceased providing cluster services also referred to as application services and does not present a threat to data integrity and optionally has preserved latent data of the rogue node 206.

Advantageously, preservation of latent data may have additional benefits depending on how nodes 206 track, log, and queue data for storage on persistent storage media. For example, a rogue node 206 may maintain commit log records as well as the actual data updates. Preserving those log records using the present invention can significantly reduce log recovery time for cluster applications that implement log-based recovery after failover.

Certain embodiments may not include a confirmation module 308. Instead, the apparatus 300 may trust that the rogue node 206 received the shutdown message 214 and has complied. The apparatus 300 may wait for a predefined period after sending the shutdown message 214 to permit the rogue node 206 to shutdown. Then, a failover process may continue. Typically, fencing is part of the failover process.

Preferably, the apparatus 300 is implemented on every node 206 of the cluster 202. Consequently, any node 206 could potentially be a leader node 206 “L” or a rogue node 206 “R.” Accordingly, each apparatus 300 is configured both to initiate verified fencing and respond to requests for verified fencing from other nodes 206. Modules for initiating fencing and responding to fencing requests may be implemented in a single apparatus or in a plurality of apparatuses.

Referring still to FIG. 3 and indirectly to FIG. 2, in one embodiment, the apparatus 300 is configured both to initiate and to respond to verified fencing requests consistent with the present invention. To respond to fencing requests, the shutdown module 306 and confirmation module 308 may perform dual functions. In addition, the apparatus 300 may include a message module 310. The functions of the message module 310 and dual functions of the shutdown module 306 and confirmation module 308 may operate independently of each other, in response to periodic time intervals, in response to events triggered in other modules 306, 308, 310, or the like.

The message module 310 periodically checks the receive message box 218 for new messages such as a shutdown message 214. When the node 206 executing the apparatus 300 is considered a rogue node 206, the message module 310 reads a shutdown message 214 from the storage device 302.

In response to a shutdown message 214, the shutdown module 306 is further configured to initiate shutdown commands to shutdown the apparatus 300 and/or the node 206 that includes the apparatus 300. As discussed above, these shutdown commands may comprise a soft shutdown that permits the apparatus 300 and/or node 206 to move latent I/O data out to persistent storage 222. Alternatively, the shutdown command may simply issue a notice to executing processes that power to the node 206 will be terminated within a very short period.

In one embodiment, once the shutdown module 306 is about to terminate power, the confirmation module 308 may send a shutdown ACK 226 to the sender of the shutdown message 214 by way of the response message box 220 of the shared storage device 302. Then the shutdown module 306 may actually terminate power to the node 206 and apparatus 300. Alternatively, the apparatus 300 may be configured such that the confirmation module 308 sends the shutdown ACK 226 as an initial operation once the node 206 and apparatus 300 restart.

In still other embodiments, the present invention may be used in combination with other proposed fencing solutions described above. In particular, the shutdown message 214 may constantly comprise a soft shutdown message. This gives the rogue node 206 an opportunity to preserve latent data. Then, the shutdown module 306 on a leader node 206 may be configured to wait for a predefined time for the shutdown ACK 226. If the time expires and no shutdown ACK 226 is received, the leader node 206 may initiate a fencing solution such as STONTIH or SCSI reserve to fence off the rogue node 206.

Optionally, certain embodiments of the apparatus 300 may also include an interface 312, a parallel operation module 314, and a warning module 316. As mentioned above, the shutdown message 214 may comprise a hard shutdown message or a soft shutdown message. For example, node 206 running a UNIX type of operating system a hard shutdown message may cause the shutdown module 306 to execute a halt or poweroff command. Still in a UNIX like environment, a soft shutdown message may cause the shutdown module 306 to execute a shutdown command. Of course these commands or others may be initiated by the shutdown message 214. For example, a soft shutdown message may execute a script that causes all I/O buffers (latent I/O data) to be immediately transferred to persistent storage 222.

The interface 312 allows a user to selectively define whether the shutdown message is a hard shutdown message or a soft shutdown message. The interface 312 may comprise a command line interface, a configuration file, a script, a Graphical User Interface, or the like. Alternatively, the interface 312 may comprise a configuration module. Consequently, a user can configure whether an apparatus 300 sends a hard shutdown message or a soft shutdown message. If a hard shutdown message is sent, the rogue node 206 will be fenced and confirmation of this fencing will occur much faster than if a soft shutdown message is sent. However, latent I/O data on the rogue node 206 may be lost. If a soft shutdown message is sent, the rogue node 206 provides time for the latent I/O data to be moved to storage 222. This extra time delays the fencing process but ensures that latent I/O data is preserved.

The parallel operation module 314 conducts a reformation process concurrently with verified fencing of the rogue node 206. Once a network cluster partition occurs, the members of the cluster 202 attempt to reform the cluster 202 and overcome the fault that caused the network cluster partition. The reformation process may take some time and typically involve a N-phase commit process where N is two or higher. Those of skill in the art will recognize that various reformation processes may be implemented.

A leader node 206 typically manages the reformation process. The leader node 206 is typically selected as a top priority in the reformation process. Again various selection mechanisms may be used to select the leader node 206. A node 206 that was leader prior to the cluster partition may be re-selected. Cluster nodes 206 may elect a new leader node 206. A system administrator may explicitly designate a leader node 206.

Once a leader node 206 is designated, the leader node 206 typically coordinates the remainder of the reformation process. In typical reformation processes, a first phase prepares the nodes to agree to a new cluster view. During this phase, the leader node 206 may be designated. In the second phase, nodes 206 are asked if they are prepared to commit the changed cluster view. Once acknowledgements from all cluster nodes 206 are received, a commit of the proposed changes is made simultaneously. Those of skill in the art will recognize that the reformation process involves various message exchanges, assessment tests, and the like.

Advantageously, concurrent with conducting the reformation process, a leader node 206 implementing the apparatus 300 can send shutdown messages 214 to one or more rogue nodes 206. The parallel operation module 314 may monitor and manage a first thread of the leader node 206 that conducts reformation and a second thread of the leader node 206 that conducts verified fencing using the apparatus 300. In addition, the parallel operation module 314 may handle any error events experienced by these concurrently executing threads or processes. Alternatively, or in addition, the parallel operation module 314 may interleave operational steps of reformation with those of verified fencing in order to reduce the time required to complete both operations.

In this manner, the verified fencing of the present invention is conducted at substantially the same time as cluster reformation. This concurrent operation may save considerable time in permitting a cluster 202 to quickly recover from a cluster partition, network fault.

In one embodiment, the apparatus 300 enables transmission of a request/response type of a shutdown message between a leader node 206 and rogue node 206. Alternatively or in addition, the warning module 316 permits the apparatus 300 to use the shared storage device 302 for communicating another type of message that may be useful in cluster management.

For example, a cluster partition may cut a first section of a cluster 202 off from network communication with a second section of a cluster 202. Each cluster section may then attempt to take over and reform the cluster. However, with a loss of network communication between the sections, in conventional clusters 202 nodes 206 in the first section are unable to communicate with nodes of the second section.

The warning module 316 of the apparatus 300 provides a secondary communication mechanism, message exchange on the storage device 302. In one embodiment the warning module 316 sends a warning message from a first cluster section to a second cluster section. The warning message may alert the second cluster section to take control of the cluster 202 if the first cluster section fails to gain control of the cluster 202. Warning messages may be sent from any node 206. Preferably, a warning message is sent by a leader candidate node 206. A leader candidate node 206 is a node that presumes to be the leader but must still receive the consent of all the nodes 206 within the newly forming cluster.

Alternatively, the warning module 316 in certain embodiments may be used to exchange other useful message between nodes 202 in a cluster in which a primary communication channel is unavailable. Those of skill in the art will readily recognize various other messages that the warning module 316 may facilitate exchanging to advance cluster management. Use of the apparatus 300 and its components together with the shared storage device 302 to exchange these messages is considered within the scope of the present invention.

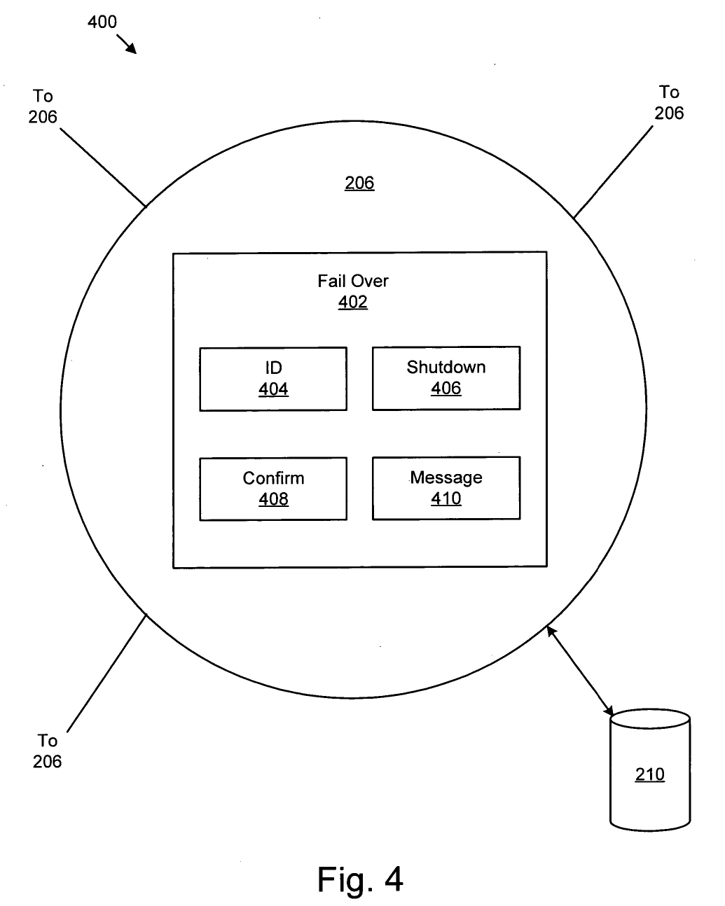

FIG. 4 illustrates a system 400 for providing verified fencing of a rogue node 206 within a cluster 202. Reference is now made directly to FIG. 4 and indirectly to FIG. 2. The system 400 includes a plurality of network nodes 206 cooperating to share hardware and software resources with disparate software applications, for example clients. Each network node 206 is capable of reading data to and writing data from a shared persistent repository 210.

Each network node 206 includes a failover module 402. Among other operations the failover module 402 is configured to fence rogue nodes 206 and confirm that fencing has actually taken place. The fail over module 402 includes an identification module 404, shutdown module 406, confirmation module 408, and message module 410. In one embodiment, the identification module 404, shutdown module 406, confirmation module 408, and message module 410 function in substantially the same manner as the identification module 304, shutdown module 306, confirmation module 308, and message module 310 described in relation to FIG. 3.

As described above, the present invention provides a highly reliable secondary communication channel that enables verified fencing of a rogue node 206 in the event of a network fault. Specifically, a disk-based communication protocol is used to fence the rogue node by exchanging messages on a shared data storage device 210 (See FIG. 2). Exchanging messages on a shared storage device 210 in a distributed environment can present a few obstacles. It should be noted that the use of other communication protocols are within the scope of the present invention.

One challenge is to provide disk-based communication that minimizes single points of failure on a cluster. Other issues relate to matters of timing, concurrent access, and the like. However, embodiments of the present invention are designed to avoid these difficulties. The present invention includes a disk-based communications protocol that is simple and effective, does not require a single, centralized message manager that may comprise a single point of failure, and handles timing and concurrent access issues, as discussed below.

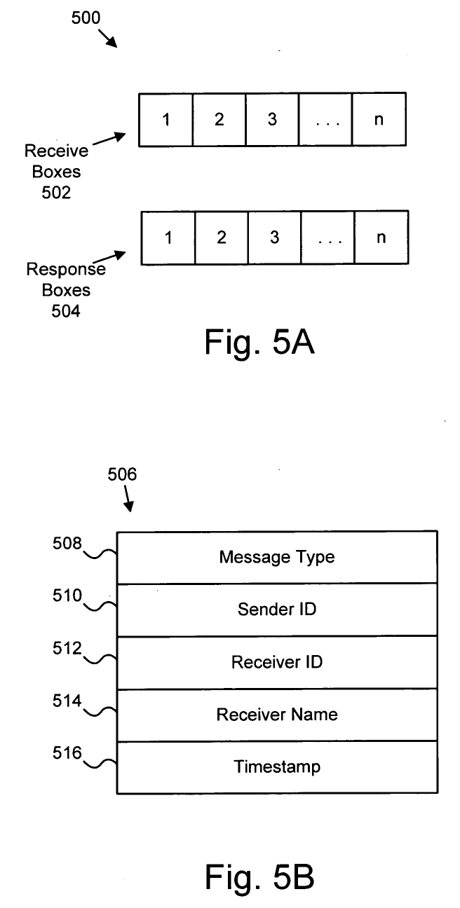

One of the initial challenges in disk-based message passing is preserving message integrity through proper handling of over-writes. FIG. 5A illustrates one embodiment of data structures suitable for implementing the disk based message protocol of the present invention. A set of receive message boxes 502 suitable for implementing the receive message box 218 illustrated in FIG. 2 is provided. Similarly, a set of response message boxes 504 suitable for implementing the response message box 220 illustrated in FIG. 2 is provided. In this manner, there is no possibility for send messages and response messages to over-write each other.

Preferably, the set of receive message boxes 502 is divided into n receive message boxes 218 (See FIG. 2) corresponding to n nodes 206 in a cluster 202 participating in the shared disk message passing. Similarly, the set of response message boxes 504 is divided into n response message boxes 220 (See FIG. 2) corresponding to n nodes 206 in a cluster 202 participating in the shared disk message passing.

In one embodiment, the response message boxes 220 and receive message boxes 218 are contiguous locations on the shared storage device 210, however, this is not necessary. The response message boxes 220 and receive message boxes 218 may each comprise an array of disk sectors. The sets of boxes 502, 504 may be stored in a single partition of a shared storage device 210.

The shared storage device 210 may be a persistent storage repository. In instances in which the shared storage device 210 is physically connected to the rogue node 206, the rogue node 206 can be rebooted without losing messages in the storage device 210.

Each response message box 220 and receive message box 218 is individually addressable either directly or indirectly. For example, each node 206 may store a starting point for the sets of message boxes 502 and an offset for each node 206 in the cluster 202. Alternatively, the offset may be implied based on a node ID and/or a server name. Of course various addressing schemes may be implemented such that each node 206 can read messages from a unique receive box 218 assigned to that node 206 and write response messages including acknowledgements to a separate response message box 220 also uniquely assigned to each node 206. The addresses may be indexed as well.

Each node 206 has an assigned receive message box 218 and an assigned response message box 220. Consequently, send messages and response messages do not over-write each other. Preferably, the shutdown ACK 226 is the only response message so over-written response messages is not ambiguous.

Keeping the number of types of messages small addresses over-writes in the response message box 220. Preferably, send messages may comprise either a shutdown message 214 or a warning message. If either of these types of messages is overwritten by a duplicate or the other type, the compliance with the message by the rogue node 206 is the intended behavior in order to provide verified fencing in accordance with the present invention.

For example, if a shutdown message 214 over-writes a warning message, the rogue node 206 complies with the shutdown message 214. Preferably, shutdown messages 214 are only sent by a single authorized node 206, the leader node 206. So, if a shutdown message 214 arrives subsequent to a warning message it is desirable that the rogue node 206 comply.

If a warning message over-writes a shutdown message 214, it is desirable that the receiving node 206 comply with the warning message, as described below. Similarly, if circumstances arise in which a warning message over-writes a warning message or a shutdown message 214 over-writes a shutdown message 214, the meaning is the same, unambiguous, and compliance is expected.

One other messaging challenge is ensuring that receiving nodes 206 comply at most once to each message found in the receive message box 218. Consequently, each node 206 may store information about the sender and timestamp for the last message read from the receive message box. If a new message is read with a later timestamp or different sender identified, the node 206 complies with the message. If not, the node 206 takes no action under certain embodiments of the present invention.

FIG. 5B illustrates types of fields that may be included in certain embodiments of messages 506 exchanged according to the present invention. These fields may be included in send messages (shutdown and warning) and/or in response messages (shutdown ACK).

One field 508 identifies the type of message such as shutdown, warning, or shutdown ACK. Another field 510 may uniquely identify the sender of the message 506. The sender may comprise a node identifier, a server identifier, or any other identifier for the module that provided the message 506. One field 512 may uniquely identify the intended receiver of the message 506. Again, the receiver may comprise a node or server. To facilitate identifying the recipient, a field 514 may include a unique name of the receiving server or node. A timestamp field 516 may record when the message was sent. This timestamp may be compared to one stored by the node 206 in order to detect whether a message 506 is stale or not.

The message 506 may or may not have a data field. Typically, identifying the message type 508 is sufficient to enable the receiving node 206 to act in response to the message 206.

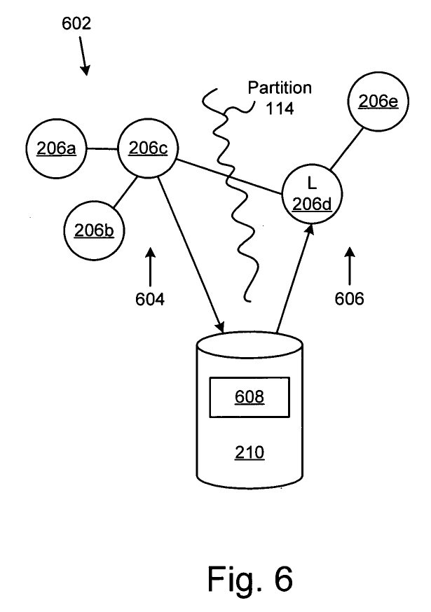

FIG. 6 illustrates one embodiment where a warning message may be communicated in accordance with the present invention. Suppose a cluster 602 of five nodes 206a-e is functioning normally with a leader node 206d managing the cluster 602. Then, a network cluster partition 114 severs network communications and divides the cluster into a first cluster section 604, the majority section 604, and a second cluster section 606, the minority section 606. Once a cluster partition occurs, the nodes 206a-e are configured to find the current leader 206d or determine a new leader 206d. The cluster partition 114 separates the majority section 604 from communication with the leader 206d. Further suppose that the leader selection/election and reformation procedures indicate that the majority section 604 is to select a leader and continue operation of the cluster 602 and that the minority section 606 is to voluntarily remove itself from the cluster 602.

However, the cluster reformation protocol seeks to ensure that some form of the cluster 602 continues operation after the partition 114. So, the minority section 606 can not presume that the majority section 604 will successfully recover the cluster 602. For example, the majority section 604 may experience one or more debilitating subsequent faults.

In certain embodiments, given the above scenario, the majority section 604 determines a leader candidate, such as node 206c. The leader candidate 206c determines that it is part of the majority section 604 and should take control of the cluster 602. In the minority section 606, the old leader 206d may become a leader candidate.

In one embodiment, just before the majority leader candidate 206c attempts to take over the cluster 602, the majority leader candidate 206c broadcasts a warning message 608 to all nodes 206a-e. Nodes 206d,e in the minority section 606 read the warning message 608 from their respective receive message boxes 218 (See FIG. 2). The warning messages 608 communicate to the nodes 206d,e in the minority section 606 that the leader candidate 206c is about to attempt to take over the cluster 206. If the take over attempt fails the minority section 606 is to take over.

Failed take over may be determined by an elapsed time. In particular, the leader candidate 206d in the minority section 606 may wait a predefined time period before attempting to take over the cluster 602. The predefined time period may be measured from when the warning message 608 is received. In this manner, if the majority leader candidate 206c fails to take over the cluster 602 due to a second fault, the minority leader candidate 206d will attempt to take over and restore cluster 602 operations with minimal delay and impact on cluster 602 performance. If the majority leader candidate 206c is successful, the minority section nodes 206d,e may be labeled as rogue and may receive a shutdown message 214 as explained above.

Of course this is one of many implementations for reformation and cluster quorum lock using the warning messages 210. Various alternative techniques may use the warning message 210 passing described above to further facilitate cluster fault tolerance. All such techniques are considered within the scope of the present invention.

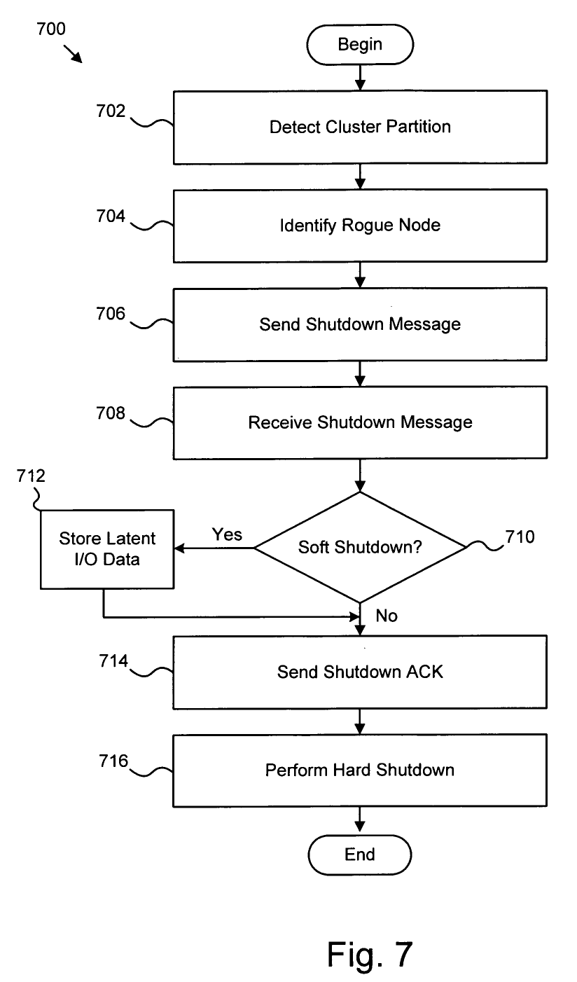

FIG. 7 illustrates a schematic flow chart diagram illustrating one embodiment of a method 700 for verified fencing of a rogue node 206. The method 700 begins once a network cluster partition occurs. First, the identification module 304 (See FIG. 3) detects 702 the network cluster partition 114 (See FIG. 1). Next, the identification module 304 identifies 704 a rogue node 206. The shutdown module 306 sends 706 a shutdown message 214 to the rogue node 206. In one embodiment, the shutdown message 214 is sent by writing it to a shared message repository 210.

Then, the rogue node 206 receives 708 the shutdown message 214 by reading from the shared message repository 210. Next, the rogue node 206 determines whether the shutdown message 214 is a hard shutdown message or a soft shutdown message. If the shutdown message 214 is a soft shutdown message, the rogue node 206 performs soft shutdown procedures that permit latent I/O data to be stored 712 in persistent data storage.

Next, the confirmation module 308 sends 714 a shutdown ACK 226 to the sender of the shutdown message 214, typically the leader node 206. The rogue node 206 then performs 716 a hard shutdown and the method 700 ends.

Advantageously, the present invention in various embodiments provides for verified fencing of a rogue node in a cluster. The present invention preserves data integrity, can prevent loss of latent data, and provides a verified fencing solution that does not depend on special hardware or immature technologies and protocols. The present invention is configurable to favor faster fencing or preservation of latent data. The present invention is also flexible enough to be used in combination with a variety of cluster management protocols including leader selection, reformation, and even convention fencing techniques such as disk leasing.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for verified fencing of a rogue node within a cluster, the apparatus comprising:
an identification module configured to detect a network cluster partition and identify a rogue node within a cluster;
a shutdown module configured to send a shutdown message to the rogue node using a message repository shared by the rogue node and the cluster; and
a confirmation module configured to receive a shutdown acknowledgement (ACK) from the rogue node, the shutdown ACK sent just prior to the rogue node shutting down.

2. The apparatus of claim 1, wherein the shutdown message is sent exclusively by a leader of the cluster.

3. The apparatus of claim 1, wherein the message repository comprises a persistent storage repository organized such that each node in the cluster is configured to read from a unique receive message box and write to a separate response message box.

4. The apparatus of claim 1, wherein the shutdown message comprises one of a hard shutdown message and a soft shutdown message, the soft shutdown message configured to permit the rogue node to move latent data to persistent storage prior to shutting down.

5. The apparatus of claim 4, further comprising an interface configured to allow a user to selectively define the shutdown message as a hard shutdown message and a soft shutdown message.

6. The apparatus of claim 4, wherein the hard shutdown message causes the rogue node to reset an I/O subsystem.

7. The apparatus of claim 1, further comprising a parallel operation module configured to conduct a reformation process for the cluster concurrent with verified fencing of the rogue node.

8. The apparatus of claim 1, wherein the network cluster partition severs network communication between a first cluster section and a second cluster section, the apparatus further comprising a warning module configured to send a warning message from the first cluster section to the second cluster section using the shared message repository, the warning message alerting the second cluster section to take control of the cluster in response to the first cluster section failing to gain control of the cluster.

9. The apparatus of claim 8, wherein each node is configured to send warning messages to each other node and wherein leader candidate node is configured to send warning messages to the other nodes in response to the leader candidate node presuming to be the leader of the cluster.

10. An apparatus for verified fencing of a rogue node within a cluster, the apparatus comprising:
a message module configured to read a shutdown message from a message repository shared by the apparatus and a cluster of nodes;
a shutdown module configured to shutdown the apparatus; and
a confirmation module configured to send a shutdown acknowledgement (ACK) from the apparatus, the shutdown ACK sent just prior to the apparatus shutting down.

11. The apparatus of claim 10, wherein the message repository comprises a persistent storage repository organized such that each node in the cluster is configured to read from a unique receive message box and write to a separate response message box.

12. The apparatus of claim 10, wherein the shutdown message comprises one of a hard shutdown message and a soft shutdown message, the soft shutdown message configured to permit the apparatus to move latent data to persistent storage prior to shutting down.

13. The apparatus of claim 10, further comprising a parallel operation module configured to conduct a reformation process for the cluster concurrent with verified fencing of the rogue node.

14. A system to provide verified fencing of a rogue node within a cluster, the system comprising:
a plurality of network nodes cooperating to share resources with disparate software applications;
a shared persistent repository accessible to each of the network nodes;
a failover module operating on each node, the failover module comprising
an identification module configured to detect a network cluster partition and identify a rogue node within a cluster;
a shutdown module configured to send a shutdown message to the rogue node using a message repository shared by the rogue node and the cluster; and
a confirmation module configured to receive a shutdown acknowledgement (ACK) from the rogue node, the shutdown ACK sent just prior to the rogue node shutting down.

15. The system of claim 14, wherein the shutdown message is sent exclusively by a leader of the cluster.

16. The system of claim 14, wherein the message repository comprises a persistent storage repository organized such that each node in the cluster is configured to read from a unique receive message box and write to a separate response message box.

17. The system of claim 14, wherein the shutdown message comprises one of a hard shutdown message and a soft shutdown message, the soft shutdown message configured to permit the rogue node to move latent data to persistent storage prior to shutting down.

18. The system of claim 17, wherein the failover module further comprises a configuration module that allows a user to selectively define the shutdown message as a hard shutdown message and a soft shutdown message.

19. The system of claim 14, further comprising conducting a reformation process for the cluster concurrent with verified fencing of the rogue node.

20. A method for verified fencing of a rogue node within a cluster, the method comprising:
detecting a network cluster partition and identifying a rogue node within a cluster;
sending a shutdown message to the rogue node using a message repository shared by the rogue node and the cluster; and
receiving a shutdown acknowledgement (ACK) from the rogue node, the shutdown ACK sent just prior to the rogue node shutting down.

21. The method of claim 20, wherein the shutdown message is sent exclusively by a leader of the cluster.

22. The method of claim 20, wherein the message repository comprises a persistent storage repository organized such that each node in the cluster is configured to read from a unique receive message box and write to a separate response message box.

23. The method of claim 20, wherein the shutdown message comprises one of a hard shutdown message and a soft shutdown message, the soft shutdown message configured to permit the rogue node to move latent data to persistent storage prior to shutting down.

24. The method of claim 23, further comprising selectively defining the shutdown message as a hard shutdown message and a soft shutdown message.

25. The method of claim 20, further comprising conducting a reformation process for the cluster concurrent with verified fencing of the rogue node.

26. The method of claim 20, wherein the network cluster partition severs network communication between a first cluster section and a second cluster section, the method further comprising sending a warning message from the first cluster section to the second cluster section using the shared message repository, the warning message alerting the second cluster section to take control of the cluster in response to the first cluster section failing to gain control of the cluster.

27. The method of claim 20, wherein each node is configured to send warning messages to each other node and wherein a leader candidate node is configured to send warning messages to the other nodes in response to the leader candidate node presuming to be the leader of the cluster.

28. A signal bearing medium tangibly embodying a program of machine-readable instructions executable by a digital processing apparatus to perform operations to verify fencing of a rogue node within a cluster, the operations comprising:
operation to detect a network cluster partition and identify a rogue node within a cluster;
operation to send a shutdown message to the rogue node using a message repository shared by the rogue node and the cluster; and
operation to receive a shutdown acknowledgement (ACK) from the rogue node, the shutdown ACK sent just prior to the rogue node shutting down.

29. The signal bearing medium of claim 28, wherein the message repository comprises a persistent storage repository organized such that each node in the cluster is configured to read from a unique receive message box and write to a separate response message box.

30. A signal bearing medium tangibly embodying a program of machine-readable instructions executable by a digital processing apparatus to perform operations to verify fencing of a rogue node within a cluster, the operations comprising:
a means for detecting a network cluster partition and identifying a rogue node within a cluster;
a means for sending a shutdown message to the rogue node using a message repository shared by the rogue node and the cluster; and
a means for receiving a shutdown acknowledgement (ACK) from the rogue node, the shutdown ACK sent just prior to the rogue node shutting down.
